(19) United States
(12) Patent Application Publication
(10) Pub. No.: US 2005/0229389 A1
(43) Pub. Date: Oct. 20, 2005

(54) Heat sink fins processing installation

(76) Inventor: Yung-Cheng Chen, Hsinchu City (TW)

Correspondence Address: TROXELL LAW OFFICE PLLC, SUITE 1404, 5205 LEESBURG PIKE, FALLS CHURCH, VA, 22041, US

(21) Appl. No.: 11/044,076

(22) Filed: Jan. 28, 2005

(30) Foreign Application Priority Data
Apr. 15, 2004 (TW) 093205793

(51) Int. Cl. F28F 7/00; B23P 15/26

(52) U.S. Cl. 29/727; 29/726; 29/890.03

(57) ABSTRACT

A heat sink fins processing installation comprised of a control adapted with a suction pad driven by a drive unit, a cutter fixed to and staying away from the console for a given distance being driven by another drive unit, the cutter descending to plane and cut a blank in thickness as desire; the suction pad moving laterally to define the length of the fin so that one end of the fin being lifted up while another end being connected to the blank; both of the suction pad and the cutter then respectively retreating and ascending; the suction pad advancing again to allow the cutter push against the fin to an angle as desired to complete a cycle; and the cycle being repeated to make multiple fins arranged in sequence on the blank.

### BACKGROUND OF THE INVENTION

(a) Field of the Invention

The present invention is related to a heat sink fins processing installation, and more particularly, to one in simple construction, at low cost, and allows easy control of length, thickness, and spacing of fins.

(b) Description of the Prior Art

More heat created and to be dissipated from electronic devices including the CPU as a result of rapid development of the computer industry. To effectively dissipate such intensive heat out of the system thus to permit the heat generating devices to work within the acceptable range of temperature, a heat sink with greater area is adapted to the surface of the heat generating device to effectively dissipate the heat and/or to fast dissipate the heat for maintaining normal operation. The heat sink adapted to the CPU is essentially to dissipate the heat generated from the CPU through heat conduction. Accordingly, multiple fins are disposed on the body of the heat sink at a proper spacing among one another to increase the area to contact the air for releasing the heat from the heat source. Therefore, the size of the area for heat exchange provided by the heat sink fins basically determines the result of heat dissipation by the heat sink.

Usually, the extrusion, casting or forging method is used for the manufacturing of heat sink fins. Wherein, the extrusion method involves the use of a model to extrude a metal with high heat conduction coefficient in the model; the casting method has the liquid aluminum melted at high temperature pressurized and injected into a mold to be cooled and molded; and the forging method applies a hard mold to forge a solid metal of high heat conduction coefficient. However, the technology for reducing the thickness of the fin is not yet matured, and the resultant fin occupies greater space, meaning, the failure to increase the area of effective heat dissipation, thus to improve heat dissipation rate for a heat sink fin of the same size.

### SUMMARY OF THE INVENTION

The primary purpose of the present invention is to provide a heat sink fins processing installation that is simple in construction, at low cost, and allows easy control of the length and thickness of each fin and the spacing among multiple fins to improve work efficiency of the heat sink fins.

To achieve the purpose, a suction pad driven by a drive unit is axially provided to a console, and a cutter driven by another drive unit is fixed to and staying away from the console at a given space. The cutter is driven to descend for a given distance to plane and cut a blank for a specified thickness for a fin while the suction pad is driven to laterally advance for a specified distance to define the length of the fin. The fin has one end lifted up and the other end connected to the blank. The suction pad then retreats and the cutter ascends for a given distance before the suction pad advances once again for the cutter to push against the fin for an angle as desired to complete a cycle. By repeating the cycle, multiple fins are arranged in sequence on the blank.

### BRIEF DESCRIPTION OF THE DRAWINGS

FIG. 1 is a perspective view of the present invention.

FIG. 2 is a schematic view showing the construction of the present invention.

FIGS. 3 through 9 are schematic views showing the process step-by-step of the present invention.

FIG. 10 is a schematic view showing a construction for the adjustment of the inclination of a suction pad of the present invention.

FIG. 11 is a schematic view showing another construction for the adjustment of the inclination of a suction pad of the present invention.

### DETAILED DESCRIPTION OF THE PREFERRED EMBODIMENTS

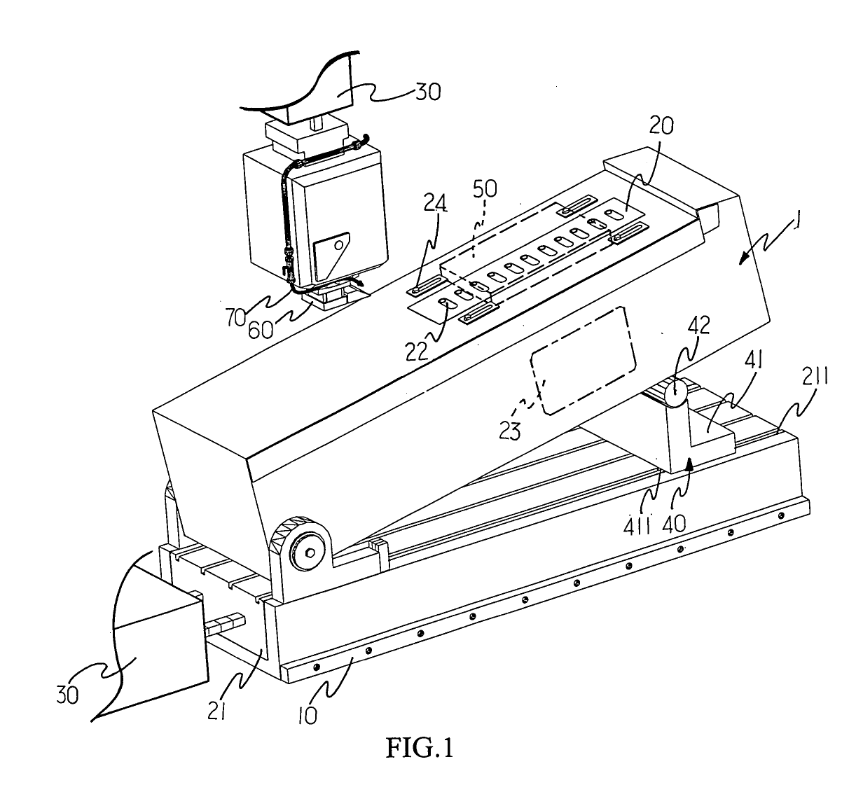

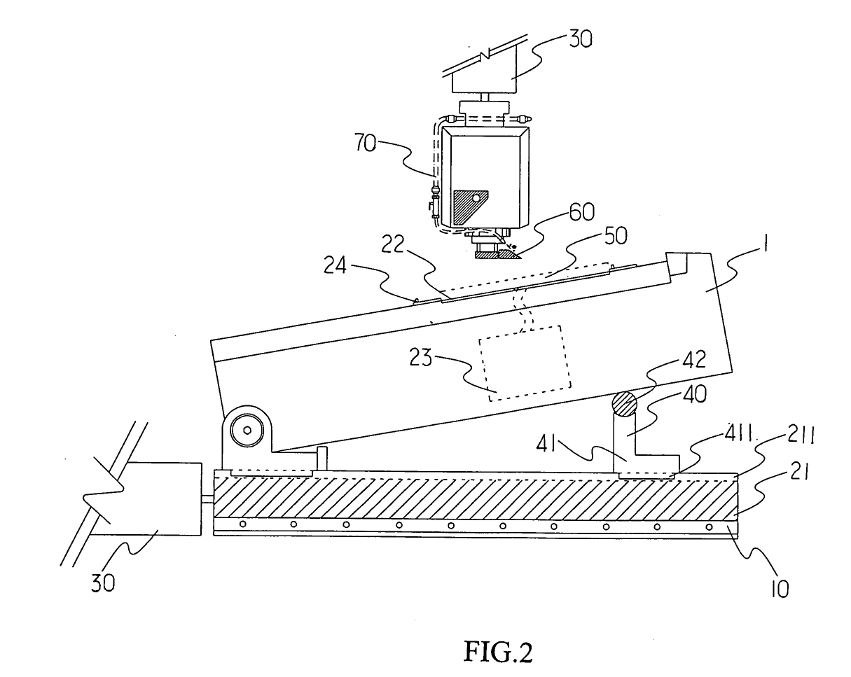

Referring to FIGS. 1 and 2 for the basic configuration of a preferred embodiment of the present invention, a processing installation 1 is essentially comprised of a console 10, a suction pad 20, and a cutter 60. The console 10 related to a mechanical structure is firmly fixed to the ground, and the suction pad 20 is placed on the console 10.

The suction pad 20 is axially provided on a slide table 21, which is mounted to the console 10. A step motor 30 in this preferred embodiment of the present invention is used to drive the suction pad 20 and the slide table 21 to laterally travel on the console 10. One end of the suction pad 20 is axially provided on one side of the slide table 21 and an elevation unit 40 is disposed at where between the other end of the suction pad 20 and the slide table 21 for the suction pad 20 to clear away from the console 10 for a given distance. Accordingly a certain inclination is defined between the suction pad 20 as a whole and the console 10. Multiple vacuum suction inlets 22 are provided on the suction pad 20 and connected to a vacuum unit, a vacuum pump 23 in this preferred embodiment. Both of the vacuum pump 23 and those multiple vacuum suction inlets 22 create negative pressure upon the a blank placed on the suction pad 20. Multiple adjustment screws 24 are provided on the suction pad to compromise the length of the individual blank 50 placed on the suction pad 20.

The cutter is fixed to and staying away from the console 10 for a given space. The cutter 60 is controlled by another step motor 30 to ascend or descend at a right angle to the console 10. The cutter 60 may be made of HSS, carbonized tungsten or alloy tooling copper knife. A hose 70 is provided at where approximately to the cutter 60 for the injection of lubricant 71 into the cutter 60.

The blank 50 is secured in place on the suction pad 20 by the negative pressure created by the vacuum pump 23 and those multiple vacuum suction inlets 22 at a certain inclination for easy penetration by the cutter 60. Depending on the length of the blank, adjustment screws are used to hold the blank 50 in position. The blank 50 may be related to any materials of high heat conduction coefficient or their combinations, such as aluminum, copper, aluminum alloy, copper alloy . . . etc.

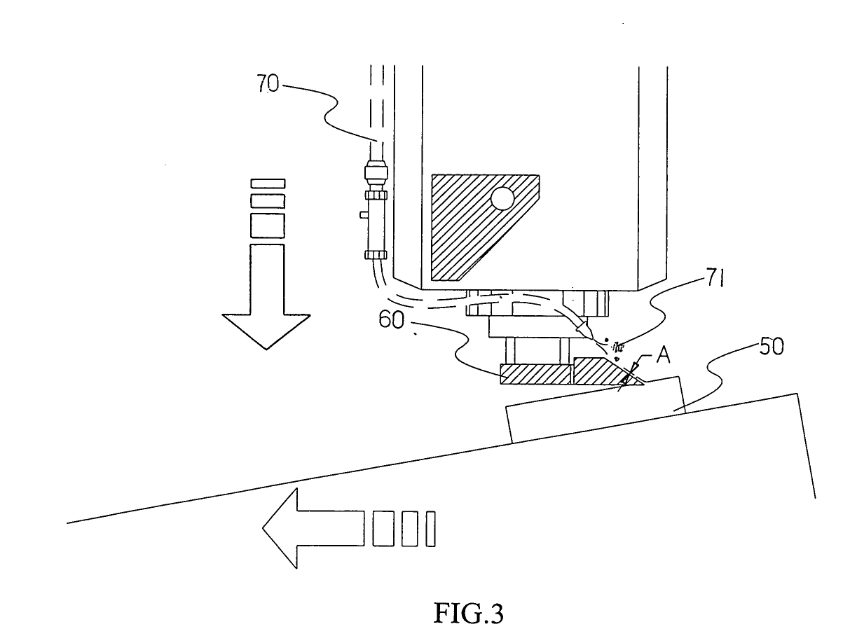

As illustrated in FIG. 3, the cutter 60 is driven by the step motor 30 to descend for a given distance to allow the cutter to penetrated into the blank and to plane a fin 51 from the blank 50 in a given thickness A.

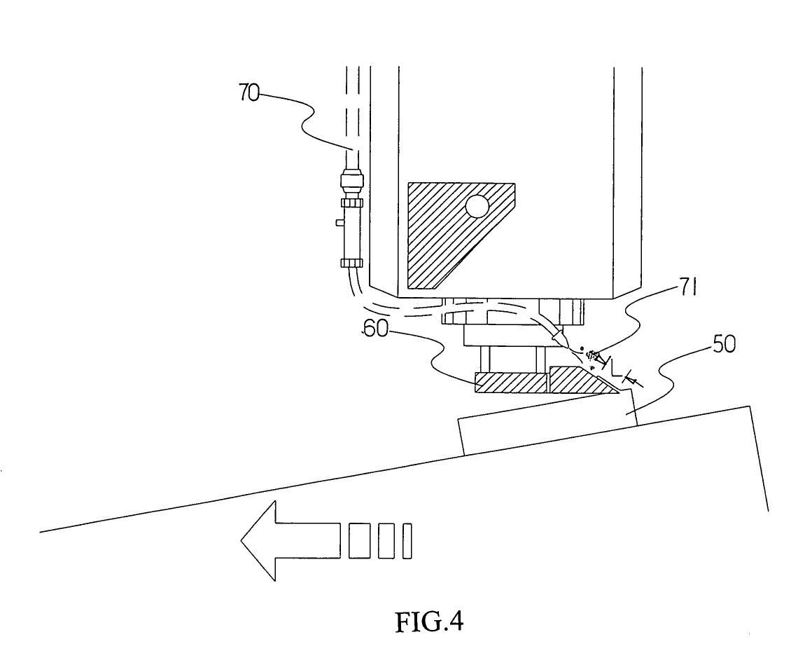

The suction pad 20 from its home is driven by another step motor 30 to advance for a given distance to determine the length L of the heat sink fin 51 as illustrated in FIG. 4. Accordingly, one end of the fin 51 is lifted up while the other end remains connected to the blank 50.

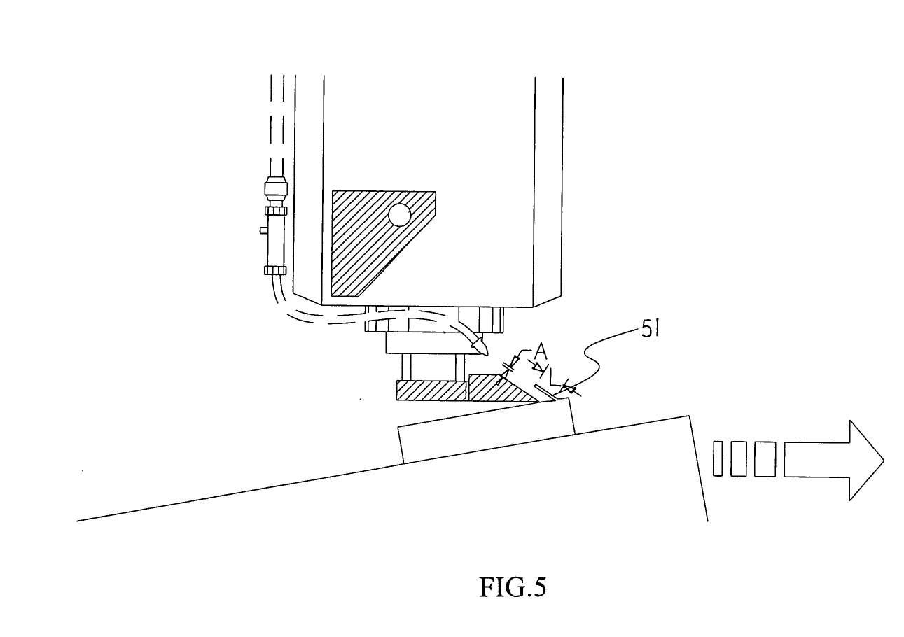

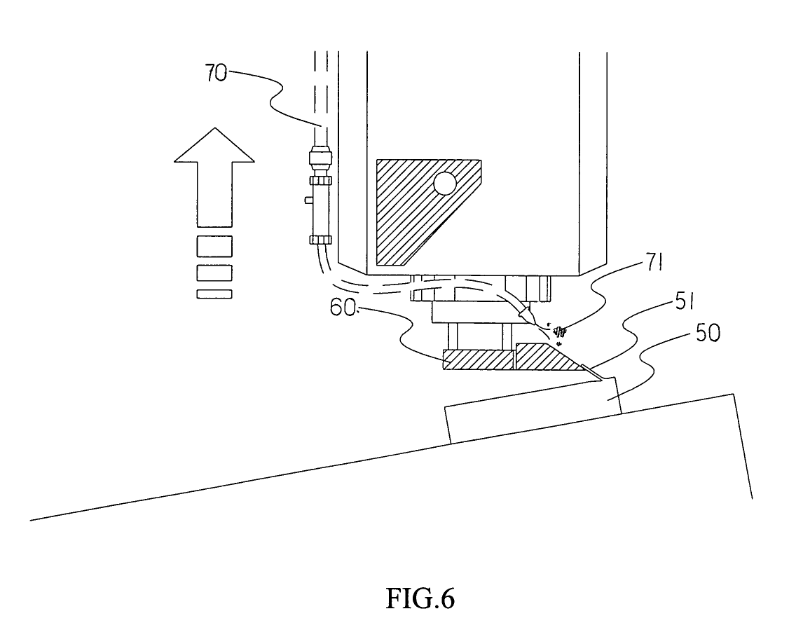

As illustrated in FIGS. 5 and 6, the suction pad 20 retreats and the cutter 60 ascends for a given distant to allow the cutter to hold against a proper location on one side of the fin.

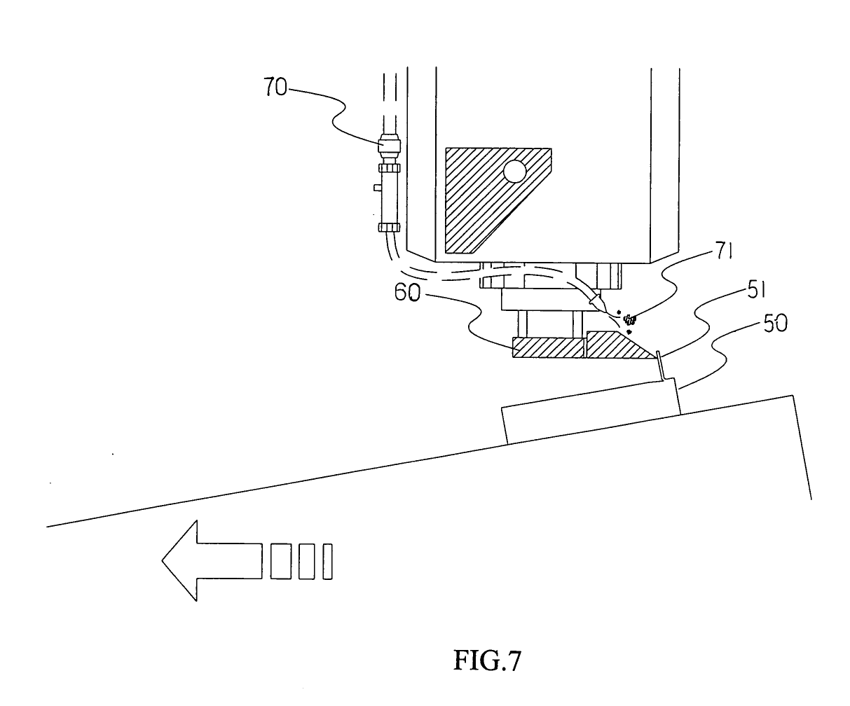

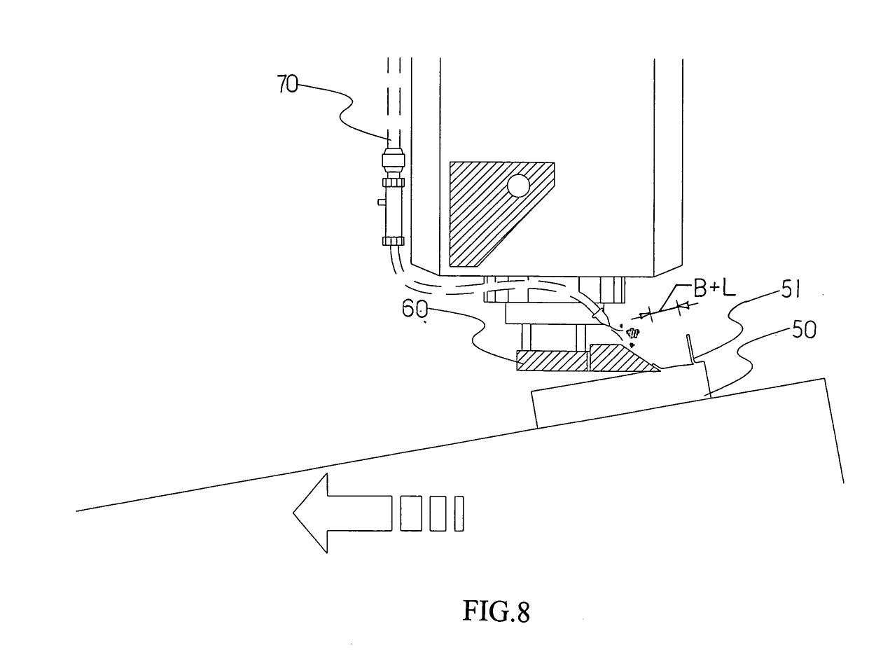

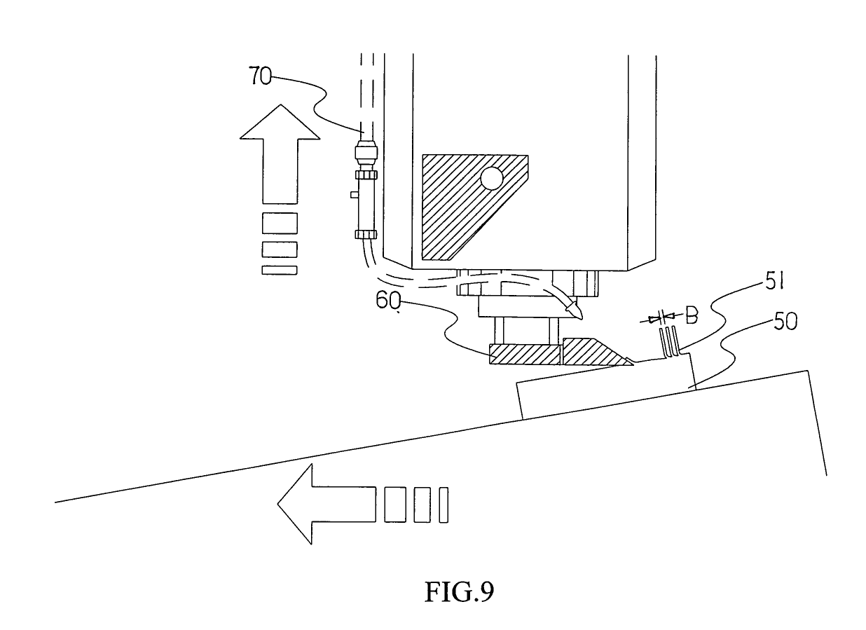

The suction pad 20 advances once again as illustrated in FIG. 7 for the cutter 60 to push the fin for an angle as desired. As illustrated in FIG. 8, the suction pad 20 first retreats to its home to advance once again for a distance equal to the sum of length L of the fin and a distance of B between two fins to execute the cutting for the next fin. As illustrated in FIG. 9, by repeating the cycle, multiple fins 51 are arranged in sequence on the blank 50.

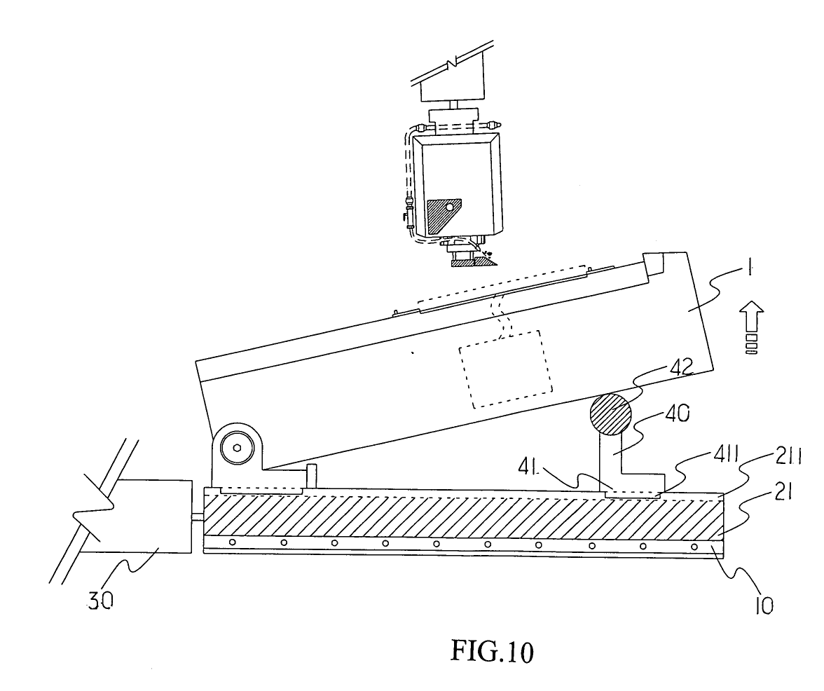

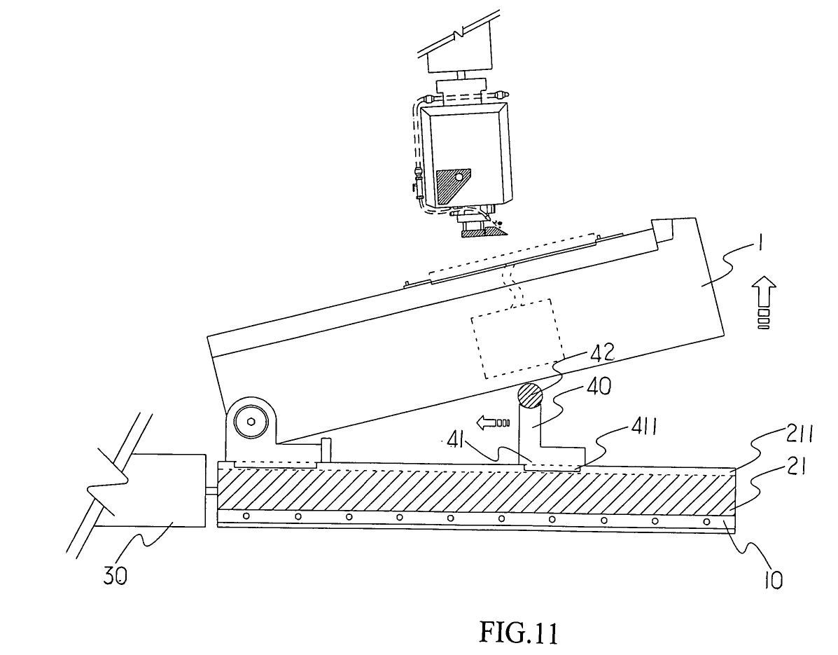

The elevation unit 40 is comprised of a block 41 and a rod 42. The rod 42 is disposed in a trough 411 of the block 41 to contact the suction pad 20. The inclination for the suction pad 20 can be changed by replacing the rod 41 with another rod 42′ in different size as illustrated in FIGS. 2 and 10. Alternatively as illustrated in FIG. 41, a track 411 and a matching channel 211 are respectively to the block 41 and the slide table 21 for the elevation unit 40 to laterally travel on the slide table to define the inclination for the suction pad 20.

The prevent invention for providing a processing installation for the heat sink fins that features simple construction, low cost, and allowing easy control of the thickness and length of the fin and the spacing among multiple fins arranged in sequence on the heat sink, the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

1. A heat sink fins processing installation includes a console related to a mechanical structure firmly fixed to the ground; a suction pad axially mounted on the consol having one end axially disposed to one side of the console and the other end staying away from the consol for a given distance to define an inclination between the entire suction pad and the console; the suction pad being driven by a drive unit to laterally travel on the console; multiple vacuum suction inlets being provided on the suction pad and connected to a vacuum unit; a blank being held in position on suction pad by negative pressure created by the suction unit and those vacuum suction inlets; a cutter being fixed to and staying away from the console for a given distance, and controlled by another drive unit to ascend or descend at a right angle to the console; the cutter as driven by the drive unit descending for a given distance to plane and cut from the blank for a fin in a given thickness; the suction pad as driven by another drive unit laterally advancing for a given distance to define the length of the fin; one end of the fin being lifted up and the other end being connected to the black; both of the suction pad and the cutter respectively retreating and ascending for a given distance; the suction pad advancing once again to allow the cutter to push against the fin to create an angle as desired to complete a cycle; and multiple fins being arranged in sequence on the blank by repeating the cycle.

2. The heat sink fins processing installation of claim 1, wherein the suction pad is axially provided to a slide table; the slide table is mounted to the console; and both of the suction pad and the slide table are respectively driven by a drive unit to slide laterally on the console.

3. The heat sink fins processing installation of claim 1, wherein the suction pad is axially provided to a slide table; the slide table is mounted to the console; both of the suction pad and the slide table are respectively driven by a drive unit to slide laterally on the console; one end of the suction pad is axially provided to one side of the slide table and the other end is provided with an elevation unit at where between the suction pad and the console to define a given distance, and thus an inclination for the entire suction pad in relation to the console.

4. The heat sink fins processing installation of claim 3, wherein the elevation the elevation unit is comprised of a block and a rod; and the rod is placed in a trough disposed on the block to contact the suction pad.

5. The heat sink fins processing installation of claim 3, wherein the elevation unit is comprised of a block and a rod; and the rod is placed in a trough disposed on the block to contact the suction pad to define the inclination for the suction pad by changing among rods of different sizes.

6. The heat sink fins processing installation of claim 3, wherein the elevation unit is comprised of a block and a rod; the rod being placed in a trough disposed on the block to contact the suction pad; and a track and a matching channel being respectively provided to the block and the slide tale for the elevation unit to laterally travel on the slide table to define the inclination of the suction pad.

7. The heat sink fins processing installation of claim 1, wherein multiple adjusting screws are provided on the suction pad.

8. The heat sink fins processing installation of claim 1, wherein a hose is provided at where appropriately to the cutter for injection of lubricant into the cutter.

9. The heat sink fins processing installation of claim 1, wherein the drive unit relates to a step motor.

10. The heat sink fins processing installation of claim 1, wherein the vacuum unit relates to a vacuum pump.
